(19) United States
(12) Patent Application Publication
(10) Pub. No.: US 2016/0260070 A1
(43) Pub. Date: Sep. 8, 2016

(54) Kvits

(71) Applicant: Denis Timchuk, Rancho Santa Margarita, CA (US)

(72) Inventor: Denis Timchuk, Rancho Santa Margarita, CA (US)

(21) Appl. No.: 14/639,106

(22) Filed: Mar. 4, 2015

(51) Int. Cl. G06Q 20/20; G06Q 20/22

(52) U.S. Cl. CPC G06Q 20/20; G06Q 20/22; G06Q 50/12

(57) ABSTRACT

Kvits is a payment platform that brings the convenience to the consumer and significantly increases the amount of sales to businesses such as restaurants, bars and other food related places. Kvits stimulates the flow of visitors to a great extent by reduction of wait time or so called the Three Waits Cycle (3W's), which includes: the wait to request a check, the wait for a check and the wait for a change or a credit card return. Kvits' platform allows to make payments for the ordered food without the presence of a server avoiding annoying waits and be on your way to your next destination faster. It is a win-win situation as for the consumer and as for the business. The way Kvits works is that each table, booth or any assigned dining area has its own unique identification placed on it. This unique ID can be in a variety of forms such as a barcode, QR code and/or some other unique identification depending on Kvits configuration and customization. When a guest is ready to leave and wants to pay for the food quickly, he/she can either go on the Kvits website or open an installed application on a smart device. When a guest inputs the unique ID into the Kvits' application, it recognizes that particular dining area (table, booth & etc.) and it brings the entire order list on a screen of a smart device along with a total amount due. By using Kvits platform, a visitor can chose either to pay for it partially or to pay off the total amount due and add any tips if so wishes. If a party has more than just one guest, Kvits also has options to split a check in various ways. Each guest simply needs to input the unique ID into their Kvits application and then the same information of an order will be available on their smart devices as well. Kvits allows to split a check evenly among the logged-in users per selected unique ID and/or pay it partially by entering a certain amount, and/or pay for the exact order by selecting each item from the entire listed order. After a guest submits the payment via Kvits platform, it communicates to the POS system that the payment was received either in full or partially and then a server can either close the bill or collect the remaining balance from the guests at that particular dining area (table, booth & etc).

### WHAT IS KVITS

Kvits is the only payment platform that brings the convenience to the consumer at the time of a check out and significantly increases the sales to businesses such as restaurants, bars and other dining and/or food related places. Kvits is a customizable software program that can be integrated into any point of sales (aka: POS) system and is an application for smart devices.

This means that a guest at a restaurant does not have to go through the 3 waits cycle (aka: 3W's). Three waits cycle is a term created by Denis Timchuk and contains the following:
Wait to request a check
Wait for a check
Wait for a change or a credit card

### HOW KVITS WORKS

Kvits is the only payment platform that allows to avoid the 3W's and be on your way. Consumers simply need to download the Kvits application onto a smart device or just go to the Kvits' website. When ready, consumers can pay the bill just by using the Kvits application on their smart device for the ordered food without the presence of a server avoiding annoying waits and be on your way to your next destination faster. Each table, booth and/or an assigned dining area for a party, has its own unique identification (aka: UID) placed on it. This UID can be in a variety of forms such as a barcode, QR code and/or some other unique identifications depending on Kvits configuration and customization. Kvits platform uses and accepts various methods of payments which includes but is not limited to credit/debit cards, PayPal accounts. When a payer scans or inputs the UID into the Kvits' application, it recognizes that particular dining area (table, booth & etc.) and it brings the entire order list on a screen of a smart device along with a total amount due. Which is a matching information of an order that was input by a server into the POS. Kvits platform has a variety of options to pay for a check. Those are:
Pay in-full or pay partially:
   Pay in-full option allows a payer to pays off a total amount due and can add any tips if he/she so wishes.
   Pay partially option allows a payer to enter an amount he/she wishes to pay via Kvits platform and a remaining balance can be covered in different forms of payment (ex.: leaving cash on a table).
Kvits has options to split a check in various ways if there is more than just one payer at the party. Split evenly, pay partially and pay per order:
   Split evenly option allows to splits a check evenly among the logged-in payers per specific UID.
   Pay partially option allows each logged-in payer per specific UID to enter an amount he/she wishes to pay via Kvits platform and a remaining balance can be covered in different forms of payment (ex.: leaving cash on a table).
   Pay per order option allows each logged-in payer per specific UID to pay for the exact ordered items by selecting each item from the listed order on a screen.

After a payer submits a payment via Kvits platform, it communicates to the POS system that the payment is received either in full or partially, depending on selections made by guests. At this point a server either can close the bill or collect the remaining balance from the party. If the bill is closed, the Kvits platform recognizes it as a completed cycle and clears the UID and it is ready to accept and operate new orders.

1. Kvits is a customizable software program and an application for smart devices (such as smart phones, tablets and etcetera) that can be integrated into, and be compatible with any POS (aka: point of sale) system as well as it can operate as an independent payment platform with a use of wireless devices (such as smart phones, tablets and etc) that conveniently eases and speeds up the payment process for the consumer for the ordered goods in the absence of a server (aka: waiter, waitress) at restaurants, bars and other food/dining related places;
Kvits platform allows to make payments for the ordered food without the presence of a server and the way it works is each table, booth or an assigned dining area has its own unique identification (aka: UID) placed on it;
this unique identification can be in a variety of forms (such as a barcode, QR code and/or some other unique identification) depending on Kvits configuration and customization;
by going on the Kvits website or by opening an installed application on a smart device (such as smart phones, tablets and etc), a payer inputs the unique ID into the application and then it brings the entire order list on a screen of a smart device (such as smart phones, tablets and etc) along with a total amount due for that particular party at the assigned dining area (such as a table, booth and etc), which is a similar or a matching information of an order that was input by a server into the POS (aka: point of sale).

2. Kvits platform uses and accepts various methods of payments which includes but is not limited to credit/debit cards, PayPal accounts; and a payer either can chose to pay a check in-full and add tips if so wishes or pay for it partially by entering an amount they wish to pay via Kvits platform and a remaining balance due can be paid in different forms of payment;
if a party has more than just one guest (aka: payer), Kvits also has options to split a check in various ways; in this case each guest (aka: payer) simply needs to input the unique ID into their Kvits application and then the same information of an order will be available on their smart devices as well;
Kvits platform allows to split a check evenly among the logged-in users (aka: payers, guests) per selected unique ID;
Kvits platform allows each guest (aka: payer) to pay a check partially by entering an amount they wish to pay;
Kvits platform allows each guest (aka: payer) to pay for the exact ordered items by selecting each item from the listed order on a screen.

3. After a guest (aka: payer) submits a payment via Kvits platform, it communicates to the POS (aka: point of sale) system that the payment is received either in full or partially, depending on selections made by guests, and then a server (aka: waiter, waitress) can either close the bill or collect the remaining balance from the guests at that particular dining area (table, booth & etc); and if the bill is closed, the Kvits platform recognizes it as a completed cycle and clears the unique identification and is ready to accept and operate new orders.
